(19) United States
(12) Patent Application Publication
(10) Pub. No.: US 2017/0114613 A1
(43) Pub. Date: Apr. 27, 2017

(54) WELL RE-STIMULATION

(71) Applicant: SCHLUMBERGER TECHNOLOGY CORPORATION, Sugar Land, TX (US)

(72) Inventors: Bruno Lecerf, Houston, TX (US); Brian D. Clark, Houston, TX (US); Hongren Gu, Sugar Land, TX (US); Dmitriy Usoltsev, Richmond, TX (US); Rajgopal V. Malpani, Houston, TX (US); Brian Sinosic, Houston, TX (US)

(21) Appl. No.: 14/920,607

(22) Filed: Oct. 22, 2015

(51) Int. Cl. E21B 41/00; G01V 99/00; E21B 49/00; E21B 43/26; E21B 43/267

(52) U.S. Cl. CPC E21B 41/0092; E21B 43/26; E21B 43/267; E21B 49/00; E21B 49/008; G01V 99/005

(57) ABSTRACT

Method for well re-stimulation treatment using instantaneous shut-in pressure (ISIP) to guide the design and execution of refracturing stages. Pore pressure and optional cluster stresses are determined at a start of the treatment. Goal ISIPs for the refracturing correspond to undepleted regions of the formation, and target ISIPs versus treatment progression/stage range from about a lowest pore pressure corresponding to depleted regions of the formation up to within the goal range ISIPs. Diversion and proppant pumping schedules are designed, and the refracturing treatment is initiated in accordance with the design. ISIP is measured at stage end, and if it varies from the target ISIP, subsequent stages are modified from the design as needed to more closely match the ISIP schedule.

### CROSS REFERENCE TO RELATED APPLICATION(S)

None.

### BACKGROUND

A refracturing treatment, which is sometimes also called a “refrac”, is the operation for stimulating a well which has a history of previous stimulation by fracturing. Often, a refrac is motivated by a level of production that has declined, usually to or below an economic limit. In some cases, a refrac may boost production to a higher level and make the well economic again.

Well re-stimulation treatments usually involve a well with pre-existing perforations as well as new perforations that may be added as a part of the re-stimulation treatment. There is usually no hydraulic isolation device inside the wellbore. Diversion techniques, such as, for example, BROADBAND SEQUENCE™ treatment and/or the diverters disclosed in U.S. Pat. No. 7,036,587, U.S. Pat. No. 7,267,170, and U.S. Pat. No. 8,905,133, enable multistage fracturing treatment without using isolation devices inside the wellbore. However, the stage design for refracs applying diversion techniques remains as a considerable challenge to the industry, which must meet at least two criteria. First, the cause(s) of subpar production must be identified and the treatment must be designed to address the cause(s). For examples, the subpar production may be due to premature damage of the producing fractures, which we may refer to as “old fractures”, and the treatment would be designed to restore conductivity in the old fractures, which may involve refracturing the old fractures, which we may refer to herein as “refractures”; or the subpar production may be due to insufficient contact with the rock and unexpectedly low reservoir drainage volume, in which case the refrac would focus on developing new fractures in rock that was not fractured in the previous treatment, which we may also refer to herein as “new rock”.

The second criterion is that the overall treatment cost must respect the economic constraints and be proportional to the production improvement, viz., it is not realistic to use sophisticated completion systems, excessive amounts of sand, fracturing fluid additives, or other stimulating material, and/or excessive horsepower, i.e., an unrealistic number of fracturing pumps.

Previous efforts have focused on refrac candidate recognition, i.e., the selection of wells suitable for refrac, such as in L. P. Moore et al., “Restimulation: Candidate Selection Methodologies and Treatment Optimization”, SPE 102681 (2006), and R. E. Barba, “A Novel Approach to Identifying Refracturing Candidates and Executing Refracture Treatments in Multiple Zone Reservoirs”, SPE 125008-MS (2009); or on refrac techniques using fracturing slurry stages and diverters, such as in M. Craig et al., “Barnett Shale Horizontal Restimulations: A Case Study of 13 Wells”, SPE 154669 (2012), and D. I. Potapenko, “Barnett Shale Refracture Stimulations Using a Novel Diversion Technique”, SPE 119636 (2009).

The industry has an ongoing need for the development or improvement of methods to design and execute refracturing treatments in accordance the above criteria.

### SUMMARY OF DISCLOSURE

In one aspect, embodiments of the present disclosure relate to a method to design and execute refracturing treatments, for a wide range of treatment types. In some embodiments, the refracturing strategy comprises pumping stages of fracturing fluid separated by diversion pills to isolate a region of the wellbore and direct the fracturing fluid to particular locations or regions along the wellbore. In some embodiments, a workflow is developed to place proppant in old fractures and/or fractures in new rock via a previously hydraulically fractured wellbore, according to the depletion status of the well and applicable economic constraints, if any. In some embodiments, the instantaneous shut in pressure values (ISIPs) of the old fractures, the refractures, the new fractures in new rock, or a combination thereof, are used to guide the stage design and the execution of the refrac treatment. In some embodiments, various realizations of the workflow are presented, depending on the availability of data, tools, and resources.

In some embodiments, pore pressure and cluster stresses are optionally determined at a start of the treatment, and goal ISIPs, corresponding to undepleted regions of the formation, and target ISIPs versus treatment progression or stage, beginning with the depleted regions, are developed. In some embodiments, the diversion and proppant pumping schedules are designed, based on different levels of available information and simulating tools, and the refracturing treatment is initiated accordingly. If the ISIP at the end of a stage varies appreciably from the design, then subsequent stages may be modified to more closely match the designed ISIP schedule.

In some embodiments, a method for re-stimulation treatment of a well penetrating a formation comprises designing a diversion schedule for a number of refrac treatment stages, wherein the schedule comprises the number of stages and a target ISIP value at an end of the respective stage; designing a proppant pumping schedule for a fracture design for the stages; initiating the refrac treatment including proppant and diversion pill placement according to the proppant pumping schedule and diversion schedule; measuring ISIP at the end of the stages; and if the measured ISIP differs unsatisfactorily from the target ISIP value, then adjusting the diversion schedule, the proppant pumping schedule, or a combination thereof, for subsequent stages.

Other aspects and advantages of the disclosure will be apparent from the following description and the appended claims.

### BRIEF DESCRIPTION OF DRAWINGS

FIG. 1 graphically plots a range of instantaneous shut in pressures (ISIPs) from an initial fracture treatment setting a target for undepleted regions to be achieved in later refrac stages, and the ISIP value of the first refrac stage representative of the pore pressure in the most depleted region, for a representative example, according to embodiments of the disclosure.

FIG. 2 graphically plots different progressions of ISIP in sequential stages of the refrac of FIG. 1 in accordance with embodiments of the present disclosure.

FIG. 3 is a workflow diagram of the tasks or operations involved in a refrac stage design and implementation in accordance with embodiments of the present disclosure.

FIG. 4 is a workflow diagram of the tasks or operations involved in one example of the refrac stage design and implementation of FIG. 3 in accordance with embodiments of the present disclosure.

FIG. 5 is a workflow diagram of the tasks or operations involved in another example of the refrac stage design and implementation of FIG. 3 in accordance with embodiments of the present disclosure.

FIG. 6 is a workflow diagram of the tasks or operations involved in another example of the refrac stage design and implementation of FIG. 3 in accordance with embodiments of the present disclosure.

FIG. 7 is a workflow diagram of the tasks or operations involved in another example of the refrac stage design and implementation of FIG. 3 in accordance with embodiments of the present disclosure.

FIG. 8 is a workflow diagram of the tasks or operations for estimating cluster stress from reservoir and geomechanics simulations in accordance with embodiments of the present disclosure.

FIG. 9 is a workflow diagram of the tasks or operations for estimating cluster stress from statistical distribution of mechanical properties in accordance with embodiments of the present disclosure.

FIG. 10 is a workflow diagram of the tasks or operations for estimating cluster stress from statistical distribution of pore pressure in accordance with embodiments of the present disclosure.

FIG. 11 graphically plots an exemplary diversion target profile of ISIP versus stage for a planned refrac designed from one of the workflow diagrams of FIGS. 4-8 in accordance with embodiments of the present disclosure.

FIG. 12 is a schematic workflow diagram for real-time adjustment of stage design from measured ISIP values in accordance with embodiments of the present disclosure.

FIG. 13 is a graph of the ISIP values encountered from the initial completion fracturing of the well in the refrac of Example 1 below according to embodiments of the present disclosure.

FIG. 14 is a stress histogram of the depleted and undepleted clusters in the refrac of Example 1 below according to embodiments of the present disclosure.

FIG. 15 is an ISIP progression graph for the refrac of the Example below according to embodiments of the present disclosure.

### DEFINITIONS

“Above”, “upper”, “heel” and like terms in reference to a well, wellbore, tool, formation, refer to the relative direction or location near or going toward or on the surface side of the device, item, flow or other reference point, whereas “below”, “lower”, “toe” and like terms, refer to the relative direction or location near or going toward or on the bottom hole side of the device, item, flow or other reference point, regardless of the actual physical orientation of the well or wellbore, e.g., in vertical, horizontal, downwardly and/or upwardly sloped sections thereof.

Depth—includes horizontal/lateral distance/displacement.

Stimulation—treatment of a well to enhance production of oil or gas, e.g., fracturing, acidizing, and so on.

Re-stimulation—stimulation treatment of any portion of a well, including any lateral, which has previously been stimulated.

Hydraulic fracturing or “fracturing”—a stimulation treatment involving pumping a treatment fluid at high pressure into a well to cause a fracture to open.

Refracturing or refrac—fracturing a portion of a previously fractured well after an initial period of production. The fractures from the earlier treatment are called “pre-existing fractures”.

Shut-in pressure or SIP—the surface force per unit area exerted at the top of a wellbore when it is closed, e.g., at the Christmas tree or BOP stack.

Instantaneous shut-in pressure or ISIP—the shut-in pressure immediately following the cessation of the pumping of a fluid into a well.

Pore pressure or reservoir pressure—the pressure of fluids within the pores of a reservoir.

Reservoir—a subsurface body of rock having sufficient porosity and permeability to store and transmit fluids.

Depletion—the drop in reservoir pressure or hydrocarbon reserves resulting from production or other egress of reservoir fluids.

Depleted region or zone—an isolated section of reservoir in which the pressure has dropped below that of adjacent zones or the main body of the reservoir.

Undepleted region or zone—a section of reservoir in which the pressure has not dropped to that of adjacent depleted zones, or has not dropped substantially from the initial reservoir pressure.

Initial reservoir pressure—the pressure in a reservoir prior to any production.

Formation—a body of rock that is sufficiently distinctive and continuous that it can be mapped, or more generally, the rock around a borehole.

Well—a deep hole or shaft sunk into the earth, e.g., to obtain water, oil, gas, or brine.

Offset well—an existing wellbore close to a subject well that provides information for treatment of the subject well.

Borehole or wellbore—the portion of the well extending from the Earth's surface formed by or as if by drilling, i.e., the wellbore itself, including the cased and openhole or uncased portions of the well.

Lateral—a branch of a well radiating from the main borehole.

Interval—a space between two points in a well.

Casing/casing string—Large-diameter pipe lowered into an openhole and cemented in place.

Liner—A casing string that does not extend to the top of the wellbore, but instead is anchored or suspended from inside the bottom of the previous casing string.

Stage—a section of the lateral consisting of one or more perforation clusters with a pumping sequence comprising a proppant pumping schedule and a diversion pill pumping schedule, including pads, spacers, flushes and associated treatment fluids.

Proppant pumping schedule—a pumping sequence comprising the volume, rate, and composition and concentration of a proppant-laden fluid, and any associated treatment fluids such as an optional pad, optional spacers, and an optional flush.

Proppant—particles mixed with treatment fluid to hold fractures open after a hydraulic fracturing treatment.

Diversion pill pumping schedule or simply “diversion schedule”—a pumping sequence comprising the volume, rate, and composition and concentration of a diversion fluid and any preceding and/or following spacers.

Pill—any relatively small quantity of a special blend of drilling or treatment fluid to accomplish a specific task that the regular drilling or treatment fluid cannot perform.

Diversion material—a substance or agent used to achieve diversion during stimulation or similar injection treatment; a chemical diverter.

Divert—to cause something to turn or flow in a different direction.

Diversion—the act of causing something to turn or flow in a different direction.

Diversion pill—a relatively small quantity of a special treatment fluid blend used to direct or divert the flow of a treatment fluid.

Diverter—anything used in a well to cause something to turn or flow in a different direction, e.g., a diversion material or mechanical device; a solid or fluid that may plug or fill, either partially or fully, a portion of a subterranean formation.

Diversion target profile—a planned objective in the aggressiveness or conservativeness in the increase of ISIPs as the stages progress during a refrac treatment.

Fracture target—a planned objective in one or more fracture characteristics, e.g., conductivity and geometry, i.e., length, height, width, and degree of complexity.

Cluster—a collection of data points with similar characteristics.

Perforation—the communication tunnel created from the casing or liner into the reservoir formation, through which fluids may flow, e.g., for stimulation and/or oil or gas production.

Perforation cluster—a group of nearby perforations having similar characteristics.

Cluster stress—formation stress at a perforation cluster.

Fracture—a crack or surface of breakage within rock.

Establish—to cause to come into existence or begin operating; set up.

Determine—to establish or ascertain definitely, as after consideration, investigation, or calculation.

Design—to work out the structure or form of something, as by making a sketch, outline, pattern, or plans.

Initiate—to cause a process or action to begin.

Measure—to ascertain the value, number, quantity, extent, size, amount, degree, or other property of something by using an instrument or device.

Estimate—to roughly calculate or judge the value, number, quantity, extent, size, amount, degree, or other property of.

Adjust—to alter or move something slightly to achieve the desired fit, appearance, or result.

Model—to develop a description of a system or process using mathematical concepts or language; to develop a mathematical model.

Simulate—to create a representation or model of something, e.g., a physical system or particular situation.

Calculate—to determine the amount or number of something mathematically.

Compare—to estimate, measure, or note the similarity or dissimilarity between.

Verify—to make sure or demonstrate that something is true, accurate, or justified; confirm; substantiate.

Input—anything put in, taken in, or operated on by any process or system; data put into a calculation, simulation or computer.

Output—data or information produced, delivered or supplied by any process or system; the results from a simulation, calculation, computation, computer or other device

Modify—to make partial or minor changes to (something), typically so as to improve it or to make it less extreme.

Progression—a movement or development toward a destination or a more advanced state, especially gradually or in stages; a succession; a series.

Starting—relating to conditions at the beginning of or just prior to the beginning of a process or procedure, e.g., a re-stimulation treatment.

Initial—relating to conditions in a well, reservoir, formation, etc. at the beginning of or just prior to any production.

### DETAILED DESCRIPTION

In some embodiments, refrac candidate wells with hydraulic fractures along a horizontal lateral exhibit depletion that is highly uneven along the lateral, e.g., in tight reservoirs. In some embodiments, it is desired that the refracturing treatment of the present disclosure create effective fractures in undepleted previously fractured regions and/or new rock, where the pore pressure is close to the initial reservoir pressure; create short and wide fractures in moderately depleted regions, where the initial fractures have lost most conductivity in the near wellbore area; and create little no fractures in the most depleted regions. Therefore, in some embodiments herein, the method aims to place most, e.g., >50%, of the proppant mass in the undepleted regions, in fractures.

The degree of depletion may be directly represented by the magnitude of reservoir pore pressure, which is reflected in the formation stress, e.g., there is a correlation between stress and pore pressure, as in the following Equation (1):

$${σ}_{h} = [ \frac{{E}_{h}}{{E}_{v}} ( \frac{{v}_{v}}{1 - {v}_{h}} ) - 1 ] α {p}_{r} \qquad ( 1 )$$

where σₕ is the formation stress, pr is reservoir pore pressure, Eh and Ev are the horizontal and vertical Young's moduli, νh and νv are the horizontal and vertical Poisson's ratios, and is the poroelastic constant. In hydraulic fracturing, the instantaneous shut-in pressure (ISIP) is closely related to the magnitude of the stress, and is thus used in some embodiments herein as a proxy for pore pressure. In some embodiments herein, the present disclosure uses ISIP as a key parameter in stage design, implementation and/or in real time diagnosis of effectiveness of refrac treatments.

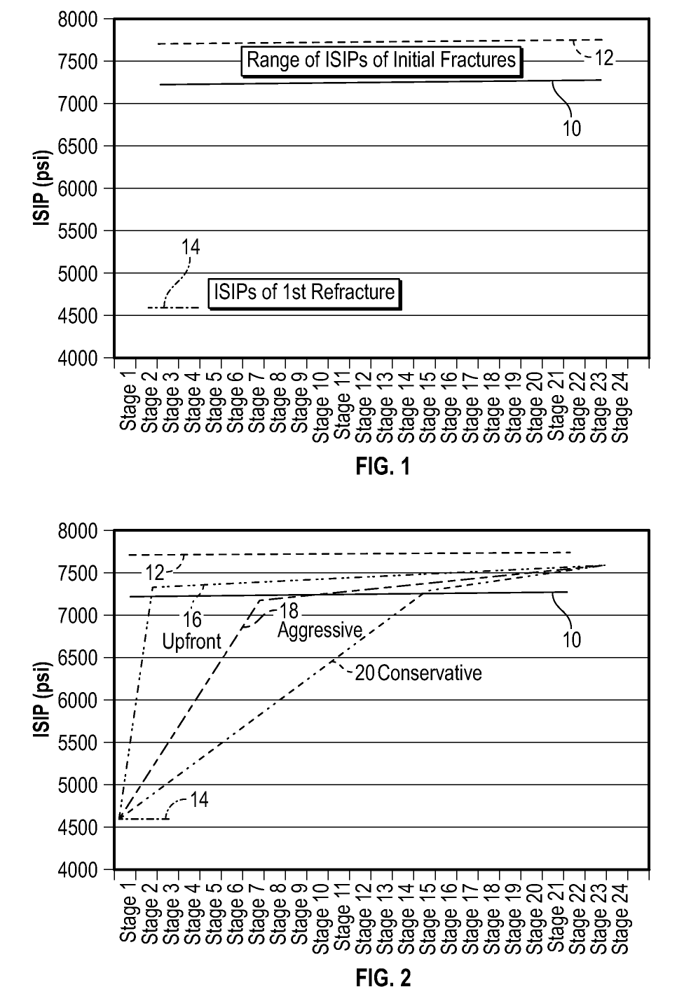

In particular embodiments, the ISIPs of the initial fracture treatment are used to set the threshold or goal for ISIPs in the refracturing treatment of undepleted regions. With reference to FIG. 1, there is usually a range between lower and upper ISIP bounds 10, 12 of the initial fracture treatment. In some embodiments, the lower bound 10 is the minimum goal value desired to be achieved in the refrac treatment, as this ISIP value represents the stress, and hence, pore pressure in the undepleted region. On the other hand, the ISIP 14 of the first refrac treatment stage represents the lowest stress, and hence the most depleted region. For example, the ISIP 14 can be measured by conducting an injection test of a small volume of fluid, since it can be assumed the injection fluid will initially enter the lowest stress or most depleted zone.

Because of the usual heterogeneity of rock properties along a horizontal wellbore and uneven depletions from the initial fractures, the stresses at the clusters are not uniform. When the pumping starts in a refrac treatment, the pressure inside the wellbore increases, and fractures are created in the first stage from the perf clusters that have the lowest stresses, following the principle of least resistance. In the subsequent stages, using a diversion technique in some embodiments, fractures are created from clusters of increasingly high stresses, and hence in less depleted regions. In some embodiments as shown in FIG. 2, this workflow allows different ISIP progressions 16, 18, 20 from low ISIP 14 to high ISIP 10, 12, to create an effective treatment and at the same time, take the risk of screenout into account. For example, if ISIP progression 16 represents the ISIP values versus stage for the upfront stimulation of the initial fracture treatment, ISIP progression 18 represents a relatively aggressive refrac with only a few stages targeting low-ISIP depleted zones, e.g., 6-7 stages, and many stages targeting the undepleted regions, e.g., 13-14 stages; whereas ISIP progression 20 is a more conservative refrac with relatively more low-ISIP stages, e.g., 14 stages, and fewer high-ISIP stages, e.g., 6 stages.

The following description herein is based on the use of a diverter such as BROADBAND SEQUENCE™ treatment by way of example and illustration, but the method is not so limited and can also be used with other placement methods, such as, for example, ball sealers, sleeves, and so on.

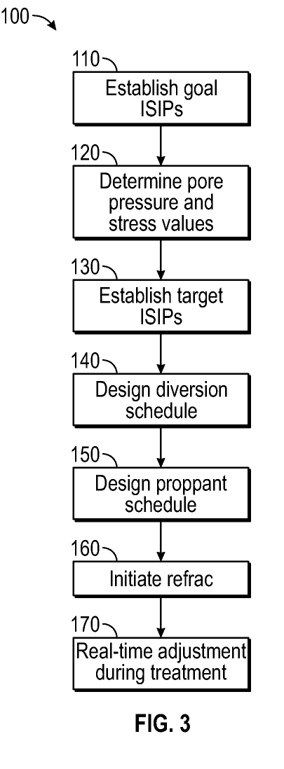

With reference to FIG. 3, an overview of workflow 100 for a refrac stage design and implementation in accordance with some embodiments of the present disclosure is shown. In task 110, a goal range of ISIP values (cf. 10, 12 in FIG. 1) for the refracturing treatment of a well is established, e.g., the minimum and maximum ISIPs of the upfront or initial multistage fracture treatment of the well from the previous or original stimulation can be used. The goal range represents ISIP values corresponding to an undepleted region(s) of the formation. The minimum ISIP in this range provides a reference for the magnitude of ISIP for fracturing into the undepleted region of the well. The maximum ISIP in the goal range provides an upper limit of the ISIP for fracturing in this well. If a refracturing treatment stage has an ISIP higher than this upper limit, a screenout may occur and require remedial steps.

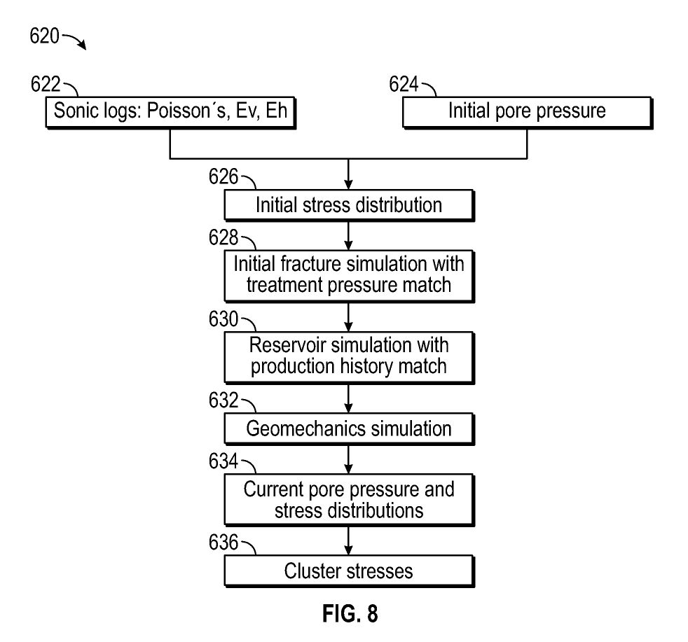

In task 120, pore pressure and cluster stresses along the well at a start of the re-stimulation treatment are determined. Various methods and models can be used, depending on the available information and tools, some embodiments of which are elaborated in more detail below in reference to FIGS. 8-10. In general embodiments, the mechanical property values for the formation along a lateral of the well for Equation (1), e.g., Poisson's ratios and Young's moduli, can be taken from logs, e.g., sonic logs, or estimated from offset or pilot wells in the formation, and so on. Pore pressures can be measured or determined from production history and/or simulations. For example, it can be assumed the pore pressure in the reservoir was uniform prior to any production, and an initial stress distribution can be calculated along the lateral using Equation (1). The pore pressure at the start of the refrac can be measured, estimated, simulated based on previous treatment parameters and production history, and so on. The current reservoir pressure field can then be calculated, which represents the depletion state in the various regions of the reservoir. Using this pore pressure field, and because stress is a function of pore pressure, the current stress field can then be calculated from a geomechanics simulation, e.g., 1D or 3D, using Equation (1), for example.

In operation 130, target ISIP values versus treatment progression, e.g., stage by stage, are established. The target ISIP values may range from a minimum target ISIP value equal to or greater than a lowest pore pressure in the formation corresponding to depleted regions (cf. 14 in FIG. 1) at a start of the re-stimulation treatment, i.e., the first stage, and a maximum target ISIP value within the goal range of ISIP values (cf. 10, 12 in FIG. 1) corresponding to the undepleted regions at an end of the re-stimulation treatment, i.e., the last or ultimate stages. These target ISIP values may also have minimum and maximum bounds for each stage representing a band of uncertainty within which the target ISIP value is deemed to have been met. If desired, the low bound of the planned ISIP profile can be verified or adjusted as needed, by conducting an injection test of a small volume of fluid to measure an ISIP, before or at the start of the refracturing treatment.

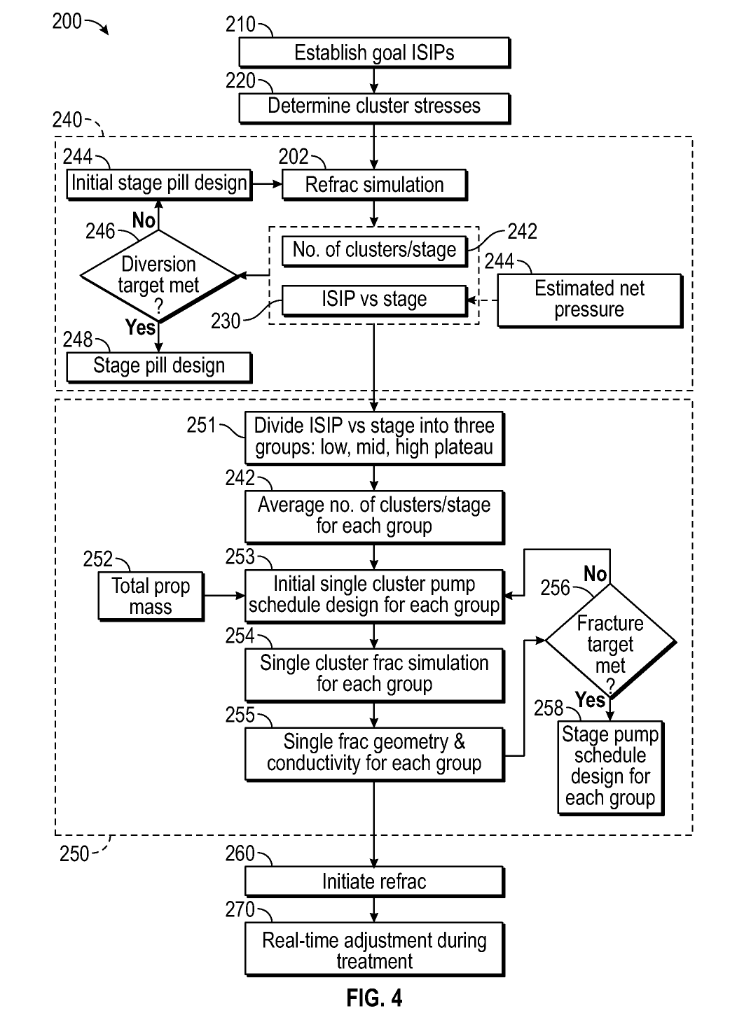

Next, a diversion strategy is designed in operation 140 and a proppant pumping schedule in operation 150. The designs in operations 140, 150, can be obtained separately in either order or simultaneously, or as part of a joint design. Operation 140 involves setting the proposed diversion target profile, e.g., the number of stages, the diversion squeeze rate, and the diversion pill volume of each stage in which a diverter is used. The diverter may or may not be used in the ultimate stage, but is usually used in at least the first through penultimate stages. Operation 150 involves setting the pumping schedule for the propped fracture treatment, e.g., the pump rate, the pad fluid volume, the proppant concentration ramp or loading schedule, and the total proppant placement for each stage. Proppant is normally pumped in each stage to hold the fracture open, however, stage steps in which no proppant is used are nevertheless deemed to be a part of the proppant pumping schedule. The diversion strategy and proppant pumping schedule can be developed using various methods and models, depending on the available data and tools, some embodiments of which are discussed below in reference to FIGS. 4-7.

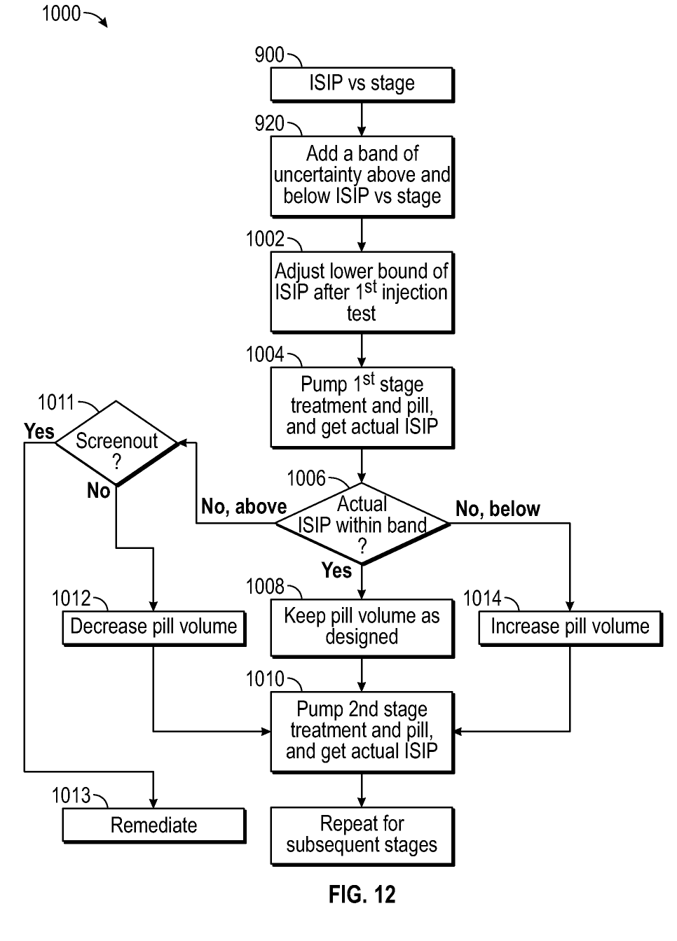

Next, the refrac treatment initiation 160 uses the proppant pumping schedule from 150 and the diversion schedule from 140. In task 170, an ISIP value is obtained following diversion at the end of the stages where it is used, compared to the target ISIP for that stage, and if necessary or desired, e.g., if it differs from the target ISIP value determined in 130 by an unsatisfactory margin, e.g., a predetermined amount, subsequent stages are adjusted in real time and/or redesigned during the refrac treatment to better meet the target ISIP in the subsequent stages, e.g., in proportion to the difference between the measured and target ISIP values. Some embodiments of the refrac initiation 160 and redesign task 170 are described below in reference to FIG. 12.

The embodiments shown in FIG. 4, wherein correspondence in the last two digits of the reference numerals with those in FIG. 3 indicate corresponding but not necessarily identical elements, illustrate another workflow 200 for the refrac stage design and implementation. The workflow 200 includes refrac simulation operation 202 using a refrac simulator, such as, for example, the BBSCFR simulator available from Schlumberger Technology Corporation, or another refrac simulator. The refrac simulator in some embodiments is a fast computer program that can determine fracture initiation, flow rate distribution, and perforation cluster plugging by diverter, with computations based on mass and momentum conservation and an algorithm that expands on the calculations for limited entry that were described in K. Wutherich et al., “Designing completions in horizontal shale gas wells—perforation strategies”, SPE 155485 (2012), to calculate the flow distribution along a wellbore interval.

In some embodiments, inputs to the refrac simulator in operation 202 may include one or more or all of the completion parameters, cluster design, estimated fracturing gradient per cluster, the amount of diverting material required to plug one perforation, the total amount of diversion pumped in the diverting pill, and so on. In some embodiments, the refrac simulation 202 functions in a 3-step sequence: (1) computation of the flow rate across each perforation cluster during a stage, and then before any diversion material is pumped at the rate at which the diverting pill is squeezed through the perforations, e.g., 20 bbl/min, along with the wellbore pressure required to flow fluid across the perforations; (2) computation of the perforation plugging progression (fraction of perforations plugged) to consume the material pumped in the diverting pill, which may be based on user input of the quantity of material required to plug a perforation, the size of the diverting pill, the squeeze rate, and so on; (3) with a fraction of the perforations plugged, computation of the flow rate across each perforation cluster at the squeezing rate (e.g., 20 bbl/min), and then at the fracturing rate of the subsequent fracturing stage. Steps 1, 2, 3 in some embodiments are employed for a single fracture simulation, or iterated for the number of fracturing stages to be pumped in the treatment.

In some embodiments, the refrac simulation 202 may ignore one or more or all of the fracture-initiation pressure, the fracture propagation and geometry, the changes in the net pressures of the fractures during diversion, and so on. While these limitations may affect a level of accuracy, they do not impair the ability to sensitize on inputs and draw valuable conclusions. In particular, the simulator can be used to understand one or more or all of the effect of stress variations along a wellbore interval on the value of the diversion pressure, the relative change in ISIP values, the number of clusters taking fluid, and so on.

The cluster design in some embodiments may be characterized by one or more or all of: number of perforations, perforations diameter, perforation coefficient, spacing from the next cluster, fracturing gradient of the zone adjacent to the cluster, and so on.

In the workflow 200, the goal ISIPs are established in task 210 and the cluster stresses determined in operation 220 as in FIG. 3, and as described in more detail in reference to FIGS. 8-10. Next, the establishment of the goal ISIPs in operation 230 is subsumed in diversion design operation 240, and based on the cluster stresses and an initial pill stage design input 241, the refrac simulation 202 calculates the number and location of the clusters where fractures are initiated for the pill of each stage. The results 242 provide the number of clusters of each stage and the minimum cluster stress vs. stage. In some embodiments, the minimum cluster stress vs. stage can be used as a proxy to calculate the ISIP vs. stage result in operation 230, since stress is usually one order of magnitude larger than the difference between ISIP and stress, viz., net pressure. In some other embodiments, an estimated fracture net pressure input 244, e.g., approximately 1.4-7 MPa (200-1000 psi) can be added to the minimum cluster stresses to obtain ISIPs.

The calculated ISIP vs stage curve from 230 can be compared with the diversion target profile in decision operation 246. If the progression of ISIP for all the stages matches the target or within an acceptable deviation, the pill stage design is completed in output 248. If not, the pill volume of certain stages can be modified for input 241, and the refrac simulation 202 repeated until the target is met.

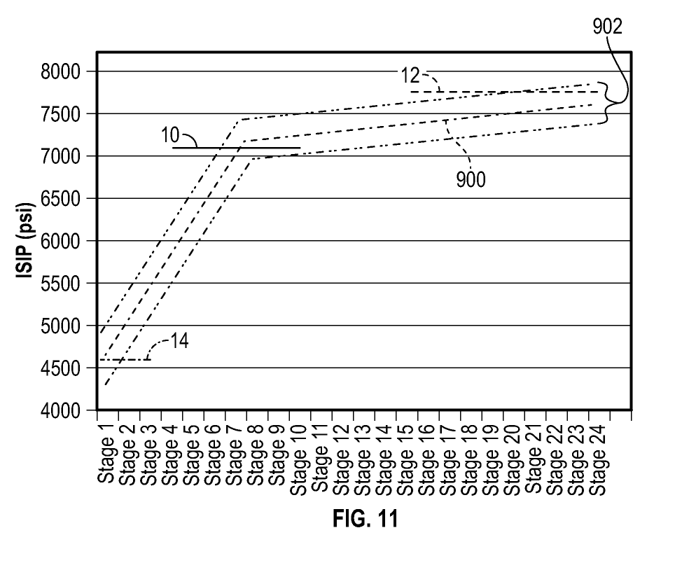

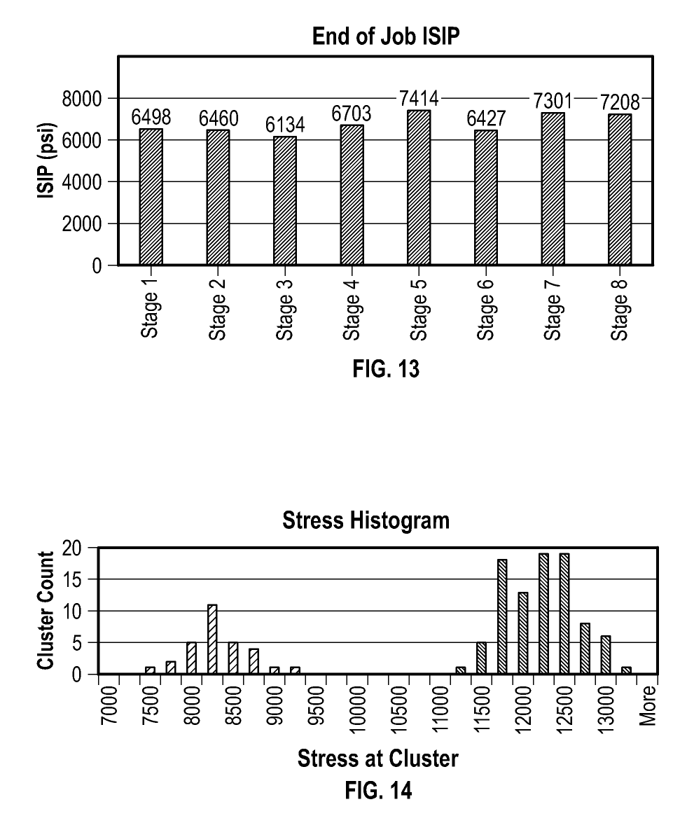

In the proppant schedule design operation 250, the stage ISIPs are divided into groups in task 251. In some embodiments, two or three or more groups may be used, e.g., low, middle, and high ISIP value groups. In some embodiments, a decision to split the stages into 2 or 3 groups depends on the gap in values of the stresses along the wellbore. For example, if there is a clear gap between the low stress (depleted region) ISIPs and high stress (undepleted region) ISIPs such as in the Example below (see FIG. 13), then only two groups are necessary, although 3 or more groups may also be selected. The high ISIP stages group form a plateau in the ISIP vs. stage curve (see FIG. 11) curve, representing a larger number of stages in the high stress, undepleted regions.

For each group, an average number of clusters per stage can be obtained from the results 242. From this and a total proppant mass input 252, which represents the main cost of a refracturing treatment, an initial proppant pump schedule for a single cluster can be designed for each group in task 253. Single fracture simulations 254 are conducted for each group, and representative fracture geometry and conductivity outputs 255 are obtained for each group. The fracture geometry and conductivity are compared with the target values in each group in decision operation 256. If the comparison is satisfactory, the proppant pump schedule design is completed in output 258. If not, the proppant pump schedules are modified in 254 and the fracture simulations 255 are repeated until the target is met. Then the refrac initiation 260 and real-time adjustments 270 are carried out as discussed in reference to FIG. 3 and/or FIG. 12.

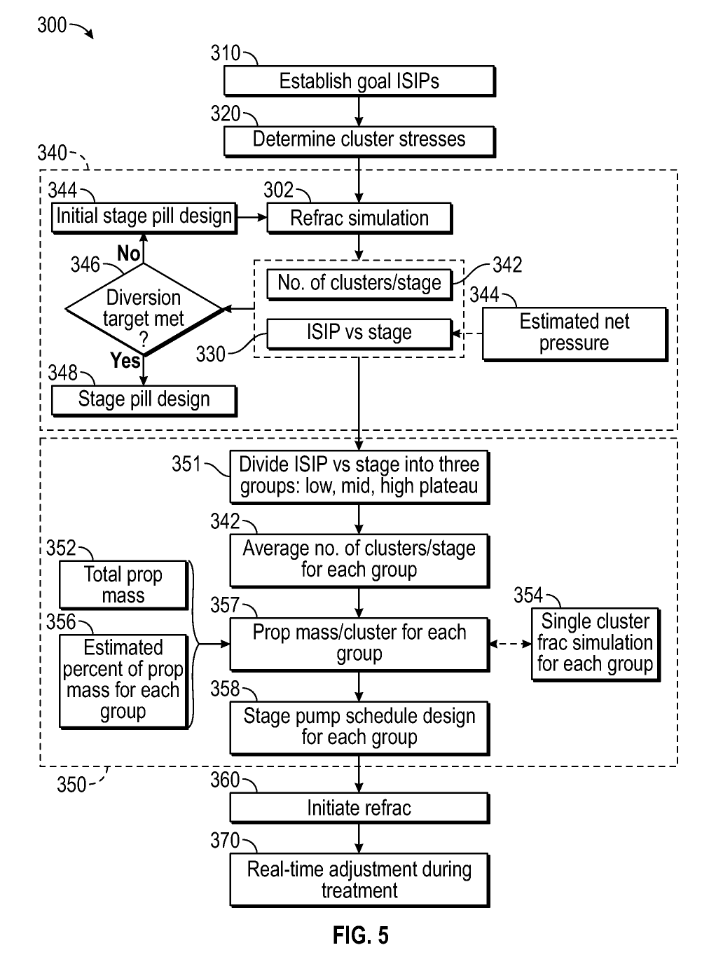

In the embodiments shown for workflow 300 in FIG. 5, wherein correspondence in the last two digits of the reference numerals with those in FIG. 3 indicate corresponding but not necessarily identical elements, the goal ISIPs are established in task 310 and the cluster stresses determined in operation 320 as in FIG. 3, and as described in more detail in reference to FIGS. 8-10. Next, the establishment of the goal ISIPs in operation 330 is subsumed in diversion design operation 340, as in FIG. 4, and based on the cluster stresses and an initial pill stage design input 341, the refrac simulation 302 calculates the number and location of the clusters where fractures are initiated for the pill of each stage. The results 342 provide the number of clusters of each stage and the minimum cluster stress vs. stage. In some embodiments, the minimum cluster stress vs. stage can be used as a proxy to calculate the ISIP vs. stage result in operation 330, since stress is usually one order of magnitude larger than the difference between ISIP and stress, viz., net pressure. In some other embodiments, an estimated fracture net pressure input (see input 244 in FIG. 4), e.g., approximately 1.4-7 MPa (200-1000 psi) can be added to the minimum cluster stresses to obtain ISIPs.

As in FIG. 4, the calculated ISIP vs stage curve from 330 can be compared with the diversion target profile in decision operation 346, and if the progression of ISIP for all the stages matches the target or within an acceptable deviation, the pill stage design is completed in output 348, or if not, the pill volume of certain stages can be modified for input 341, and the refrac simulation 302 repeated until the target is met.

In the proppant schedule design operation 350, the stage ISIPs are divided into groups in task 351, and an average number of clusters per stage can be obtained from the results 342, in the identical manner as described in reference to FIG. 4. Then, rather than conducting fracture simulations to obtain fracture geometry and conductivity as in FIG. 4, the amount of proppant mass per cluster is assigned in task 357 based on the total proppant mass input 352 and the input 356 of the estimated percent of proppant mass for each group, which may be based, for example, on experience from similar previous treatments. For example, little or no proppant may be assigned to the stages of the low ISIPs, since they are in the depleted regions; a relatively moderate amount to the stages of the mid-range ISIPs, if present, which are likely in the regions of the damaged initial fractures; and a relatively large amount to the stages of the highest ISIPs, since they will be in the undepleted regions.

An optional single cluster fracture simulation 354 can, if desired, be conducted for each group to verify the created fracture geometry and conductivity are consistent with the design for each group. Since the average number of clusters is known for each group, the amount of proppant in a stage proppant schedule is the product of the proppant mass/cluster by the average number of clusters of a stage, and the stage pump schedule design for each group in output 358 is straightforward. Then the refrac initiation 360 and real-time adjustments 370 are carried out as discussed in reference to FIG. 3 and/or FIG. 12.

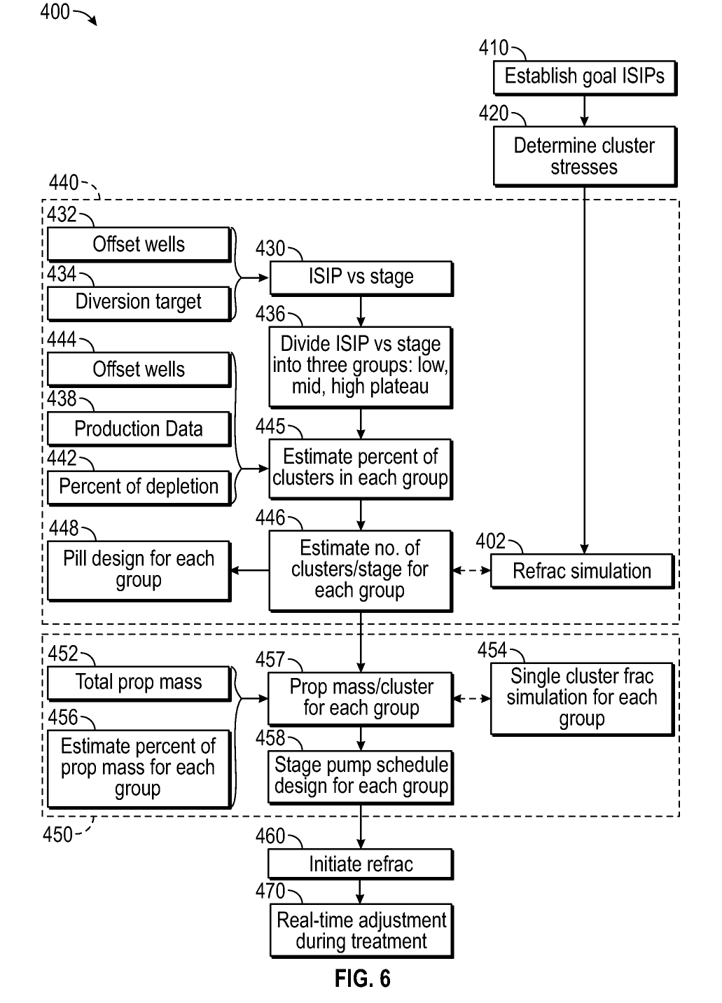

With reference to the embodiments of the workflow 400 shown in FIG. 6, wherein correspondence in the last two digits of the reference numerals with those in FIG. 3 indicate corresponding but not necessarily identical elements, the goal ISIPs are established in task 410 and the cluster stresses optionally determined in operation 420 as in FIG. 3, and as described in more detail in reference to FIGS. 8-10. In these embodiments, workflow 400 requires minimum data and simulations, but more experience and empirical knowledge may be needed. In these embodiments, operation 420 is optional since refrac simulation 402 is optional and is only required to the extent required by the refrac simulation used.

In these embodiments, an ISIP vs stage curve can be obtained in operation 430 based on data 432 from previous fracturing or refracturing in an offset wellbore, e.g., if there is a pump shutdown at the end of each stage of treatment in the offset well. The ISIP vs stage curve can be further modified toward the input 434 for the planned diversion target profile ISIP progression for all the stages. Next, in the diversion design operation 440, the stage ISIPs are divided into groups in task 436. In some embodiments, two or three or more groups may be used, e.g., low, middle, and high ISIP value groups. In some embodiments, a decision to split the stages into 2 or 3 groups depends on the gap in values of the stresses along the wellbore. For example, if there is a clear gap between the low stress (depleted region) ISIPs and high stress (undepleted region) ISIPs such as in the Example below (see FIG. 13), then only two groups are selected, although 3 or more groups may be necessary. The high ISIP stages group form a plateau in the ISIP vs. stage curve (see FIG. 11) curve, representing a larger number of stages in the high stress, undepleted regions.

Using information of production data 438 and estimated percent of depletion along the lateral 442, as well as any data 444 from similar offset wells, the percent of number of clusters in each group is estimated in task 445. Since the total number of clusters of the lateral is known, and the number of stages in each group is determined, the average number of clusters per stage can be calculated for each group in task 446. Then the stage pill volume of each group can be calculated, using the average number of clusters to be plugged in each stage, to give the pill design for each group in output 448. As an optional calculation, the pill design from 448 for all the stages can be input to the refrac simulation 402 to verify the accuracy of the ISIP vs stage curve design.

In these embodiments, the proppant schedule design operation 450 is similar to FIG. 5, using the groups of stages set in task 436 and the clusters per stage of each group determined in task 446. Then, the amount of proppant mass per cluster is assigned in task 457 based on the total proppant mass input 452 and the input 456 of the estimated percent of proppant mass for each group, which may be based, for example, on experience from similar previous treatments. For example, as in the FIG. 5 embodiments, little or no proppant may be assigned to the stages of the low ISIPs, since they are in the depleted regions; a relatively moderate amount to the stages of the mid-range ISIPs, if present, which are likely in the regions of the damaged initial fractures; and a relatively large amount to the stages of the highest ISIPs, since they will be in the undepleted regions.

An optional single cluster fracture simulation 454 can, if desired, be conducted for each group to verify the created fracture geometry and conductivity are consistent with the design for each group. Since the average number of clusters is known for each group, the amount of proppant in a stage proppant schedule is the product of the proppant mass/cluster by the average number of clusters of a stage, and the stage pump schedule design for each group in output 458 is again straightforward. Then the refrac initiation 460 and real-time adjustments 470 are carried out as discussed in reference to FIG. 3 and/or FIG. 12.

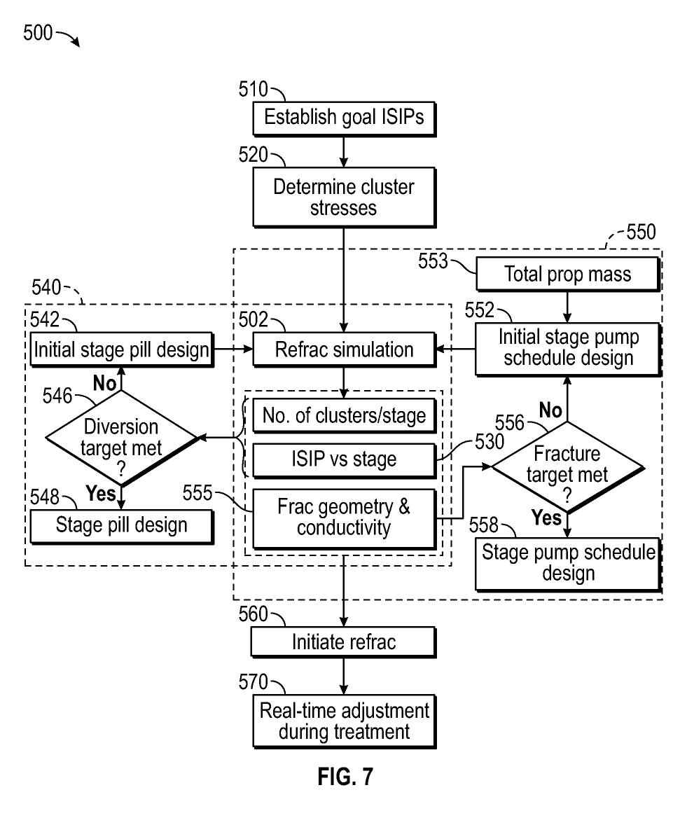

With reference to the embodiments shown in FIG. 7, wherein correspondence in the last two digits of the reference numerals with those in FIG. 3 indicate corresponding but not necessarily identical elements, the goal ISIPs are established in task 510 and the cluster stresses determined in operation 520 as in FIG. 3, and as described in more detail in reference to FIGS. 8-10, e.g. in FIG. 8 the available data and resources enable reservoir and geomechanics simulations. The workflow 500 represents an ideal case where all or most of the desired data, design tools, and resources are available.

There is an overlap of the operations 530, 540, 550 as shown in FIG. 7, where some of these operations are concurrent or simultaneous. Using the current pore pressure and stress field from operation 520, refrac simulation 502 models the initiation and propagation of multiple fractures from a number of perforation clusters in a refrac treatment. In a refrac well, the number of perforation clusters may be large, e.g., 100-200. For a given pump rate, only a limited number of fractures are created from the clusters that have the lowest stresses. In some embodiments, the simulation 502 determines the quantity and location of these clusters, based on mass conservation and momentum conservation for the pump rate, wellbore pressure, and the cluster stresses. The simulation 502 models the propagation of these fractures using an initial stage pump schedule from design task 552, which may be based on input 553 of the total proppant mass to be used. The number of clusters that have fractures and the geometry and conductivity of these fracture are obtained from the simulation 502. From initial stage pill design 542, the simulation 502 then models the injection of a diversion pill from an initial pill volume, and determines the number of clusters that are plugged by the diversion pill. An ISIP is calculated in operation 530 for the end of the pill injection when the pump rate drops to zero, i.e., pump shutdown. The simulation 502 is conducted for all the stages of pump schedule design and pill design for the entire well.

The ISIP vs. stage output in the simulation 502 is compared with the target ISIP vs stage curve from operation 530. If the simulated ISIP matches the target value of the corresponding stage in decision operation 546, the pill design is completed in output 548. If not, the initial pill design is modified in operation 542 and another simulation is run. Also, in some embodiments simultaneously or concurrently, the fracture geometry and conductivity output 555 is compared with the target values of the fracture design in decision operation 556. If the comparison is satisfactory, the stage pump schedule design for this stage is completed in output 558. If not, the volumes of fluid and proppant of the initial pump schedule is modified in design task 552 and another simulation 502 is run. These iterations are repeated until the pill design 548 and the pump schedule design 558 are completed, i.e., so that fractures are created in the entire well for all stages according to the diversion target profile and the fracture target, which are based on the desired amount of proppant placed in depleted and undepleted regions. Then the refrac initiation 560 and real-time adjustments 570 are carried out as discussed in reference to FIG. 3 and/or FIG. 12.

The workflow 620 shown in the embodiments of FIG. 8 allows the cluster stresses to be obtained by simple interpolation from the stress field at all the cluster locations along the lateral. In task 622, the mechanical properties, e.g., Poisson's ratios and Young's moduli, in the vertical and horizontal directions, are taken from available data sources, e.g., sonic logs. In task 624, the initial reservoir pressure, which can generally be assumed to be uniform in an unproduced reservoir, is taken from available data sources, e.g., initial drilling or initial completion data prior to any production, or production data at the start of any production. In operation 626, the initial stress along the lateral is calculated from the mechanical properties and the pore pressure.

Next, the initial stress distribution in the entire fracture domain can be obtained in fracture simulation 628, based on mechanical and geological models, which may, for example, be 1D or 3D. The fracture simulation 628 of the initial fracture treatment is conducted using the rock properties from 622, stress distribution 626, and treatment parameters. The pressure from the simulation is matched with the actual pressure measured from the initial treatment. The fracture geometry and conductivity calculated in the simulation 628, together with the reservoir properties, are then used in reservoir simulation 630 for the production period after the initial fracture up to the refrac. The production rate and pressure from the simulation 630 during that period used to match any actual production history data, and to calculate a reservoir pressure field at the start of the re-stimulation treatment. Next, geomechanics simulation 632, which may be 1D or 3D, is used to calculate the current stress field in output 634. Cluster stress are then determined from the stress field in task 636.

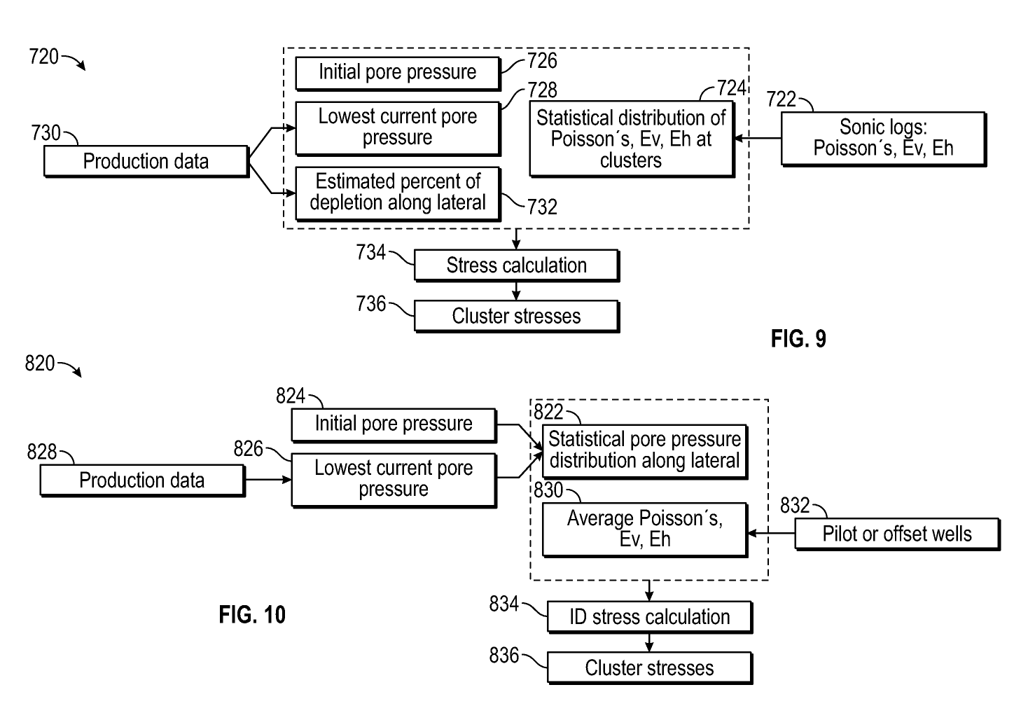

The workflow 720 shown in the embodiments of FIG. 9 uses the statistical distribution of rock mechanical properties along the lateral from input 722 to determine the cluster stresses. The mechanical properties along the lateral are taken from available data, such as, for example, sonic logs in the subject well, e.g., usually before but possibly after the initial fracturing treatment, or estimated from offset wells in the field. In task 724, statistical distributions are obtained from the measured values. The initial pore pressure for data input 726, in some embodiments, is known for a reservoir before the production from the initial fractures. The lowest current pore pressure can be estimated in task 728 from the production data 730. The percent of depletion along the lateral is also estimated in task 732 from the production data 730.

Using the mechanical properties from 724, and the pore pressure from 726, 728, 730, the stress, σₕ, can be calculated in task 734 from Equation (1):

$${σ}_{h} = [ \frac{{E}_{h}}{{E}_{v}} ( \frac{{v}_{v}}{1 - {v}_{h}} ) - 1 ] α {p}_{r} \qquad ( 1 )$$

where pr is reservoir pore pressure, Eh and Ev are the horizontal and vertical Young's moduli, νh and νv are the horizontal and vertical Poisson's ratios, and is the poroelastic constant.

In some embodiments, two pore pressures are used in the calculations: one is the initial pore pressure 726, which is in the undepleted region, and the other is the current lowest pore pressure from task 732, which is in the most depleted region. Two distributions of stress are obtained from these two pore pressures, which can be assigned to two sets of clusters, based on the estimated percent of depletion along the lateral from task 732, to provide the cluster stresses 736.

The workflow 820 shown in the embodiments of FIG. 10 uses the statistical distribution of pore pressure along the lateral determined in task 822. The initial pore pressure is assumed known in input 824, and the lowest current pore pressure 826 is estimated from the production data 828. The statistical distribution in task 822 is obtained from these two values, representing the upper and lower bound of the pore pressure. Average or representative values of Poisson's ration and Young's modulus are obtained for input 830 from data source 832, which may be, e.g., well logs, or date from a nearby pilot well(s), or from offset well(s), or the like. Equation (1) above is used to calculate the stress distribution in operation 834, using the pore pressure distribution 822 and the average values of the mechanical properties from 830. The stress distribution is then assigned to the clusters in task 836.

A representative ISIP vs. stage curve 900 according to some embodiments is shown in FIG. 11, which may be obtained in the course of following any one or combination or permutation of any of the workflows described above in FIGS. 3-7. Since assumptions and simplifications are used in the designs, in some embodiments we add an uncertainty band 902 around the ISIP vs. stage curve to establish predetermined bounds for the target ISIPs, which serve as a guide as to whether or not, depending on the measured ISIP at the end of a stage, subsequent stages of the planned refrac design should be adjusted to better meet the target ISIPs on the curve 900.

FIG. 12 provides embodiments of a workflow 1000 for real-time adjustment of the stage design from measured ISIP values. At the beginning of the refracturing treatment, in some embodiments, an injection test 1002 of a small volume of fluid is conducted, e.g., less than 20% of the volume of the first stage, to obtain an ISIP, the measured ISIP is compared with the low bound of the planned ISIP 900, and the lower bound adjusted to the measured value if needed, e.g., if it is outside the uncertainty band 902 at the first stage.

Next, in task 1004, the first stage treatment including the pill is pumped, and the ISIP is measured at the end of the stage. In decision operation 1006, the measured ISIP is compared with the planned curve 900. If the measured value is within the uncertainty band 902, the pill volume is kept as designed in task 1008, and the process proceeds to task 1010 in which the next stage is pumped and ISIP measured. If the measured ISIP is above the band in operation 1006, the process proceeds to task 1012 and the pill volume reduced for the next stage in task 1010. If the measured ISIP is below the band in operation 1006, the process proceeds to task 1014 and the pill volume is increased for the next stage in task 1010. The decision operation 1006 and the adjustment to pill volume are repeated for the subsequent stages until all stages are pumped.

### Embodiments Listing

In some aspects, the disclosure herein relates generally to well re-stimulation methods and/or workflow processes according to the following Embodiments, among others:

### Embodiment 1

A method for re-stimulation treatment of a well penetrating a formation, comprising: (a) establishing a goal range of instantaneous shut-in pressure (ISIP) values for refracturing treatment of a well having pre-existing fractures from a previous stimulation, wherein the goal range comprises minimum and maximum ISIP values corresponding to undepleted regions of the formation; (b) determining pore pressure and cluster stresses along the well at a start of the re-stimulation treatment; (c) establishing target ISIP values versus treatment progression, wherein the target ISIP values comprise a minimum target ISIP value equal to or greater than a lowest pore pressure in the formation at a start of the re-stimulation treatment corresponding to depleted regions of the formation, and a maximum target ISIP value within the goal range of ISIP values at an end of the re-stimulation treatment corresponding to the undepleted regions; (d) designing a diversion schedule for a number of stages, wherein the schedule comprises the number of stages, a diversion squeeze rate, a diversion pill volume, and the target ISIP value at an end of the respective stage; (e) designing a proppant pumping schedule for a fracture design for the stages, wherein the proppant pumping schedule comprises pump rate, pad volume, proppant loading, and total proppant placement for the respective stage; (f) initiating the refracturing treatment including proppant and diversion pill placement according to the proppant pumping schedule (e) and diversion schedule (d); (g) measuring ISIP at the end of the stages; and (h) if the measured ISIP in (g) differs from the target ISIP value in (c) by a predetermined amount, then adjusting the diversion schedule in (d), the proppant pumping schedule in (e), or a combination thereof, for subsequent treatment stages, optionally in proportion to the difference between the measured and target ISIP value.

### Embodiment 2

the method of Embodiment 1, wherein (d) comprises simulating the refracturing treatment to determine a number of clusters for fracture initiation for the diversion pill in the respective stages, to determine a minimum cluster stress for the respective stages, and to calculate the ISIP for the respective stages as a function of the determined minimum cluster stress; comparing the calculated ISIP with the target ISIP value to obtain a difference; if the difference is greater than a predetermined amount, modifying the diversion schedule and repeating the refracturing treatment simulation; and repeating the comparison and the modification until the difference is less than the predetermined amount.

### Embodiment 3

the method of Embodiment 2, wherein the refracturing treatment simulation comprises (i) computing flow rate across each unplugged perforation cluster during the stage, and a wellbore pressure required to flow fluid across the unplugged perforations, (ii) determining a fraction of perforations plugged based on the diversion squeeze rate (e.g., about 20 bbl/min), the diversion pill volume, and an amount of diverting material required to plug a perforation (preferably captured from user input), (iii) with the fraction of the perforations plugged in (ii), computing the flow rate across each perforation cluster at the squeeze rate, and (iv) repeating (i), (ii), and (iii) for subsequent stages.

### Embodiment 4

the method of Embodiment 2 or Embodiment 3, wherein the refracturing treatment simulation ignores fracture initiation pressure, fracture propagation, fracture geometry, and changes in net pressure during the diversion, and wherein the refracturing treatment simulation provides an indication of effect, of stress variations along an interval of the wellbore, on a value of diversion pressure, on relative change in the ISIP values, and on number of the clusters taking fluid.

### Embodiment 5

the method of any one of Embodiments 2-4, wherein the refracturing treatment simulation is based on cluster characterization from user inputs selected from one or more or all of: number of perforations, perforation diameter, perforation coefficient, spacing to adjacent clusters, and fracturing gradient of a zone adjacent to the cluster.

### Embodiment 6

the method of any one of Embodiments 2-5, wherein the ISIP calculation comprises adding an estimated net pressure (e.g., about 200-1000 psi) to the minimum cluster stress.

### Embodiment 7

the method of any one of Embodiments 2-6, wherein (e) comprises dividing the target ISIP values into a plurality of groups of stages comprising a low value group, a high value group, and optionally one or more intermediate value groups, e.g., intermediate value groups where the low value group and the high value group are separated by a gap between depleted and undepleted regions; calculating an average number of clusters per stage for each of the groups of stages; designing the proppant pumping schedule for one of the clusters in each of the groups of stages, based on a selected total proppant mass; simulating the designed proppant pumping schedule to calculate representative fracture geometry and conductivity for each of the groups of stages, comparing the calculated fracture geometry and conductivity with target geometry and conductivity, if the comparison is unsatisfactory, modifying the proppant pumping schedule and repeating the refracturing treatment simulation, and repeating the comparison and the proppant pumping schedule modification until the comparison is satisfactory.

### Embodiment 8

the method of any one of Embodiments 2-6, wherein (e) comprises dividing the target ISIP values into a plurality of groups of stages comprising a low value group, a high value group, and optionally one or more intermediate value groups, preferably no intermediate value group where the low value group and the high value group are separated by a gap between depleted and undepleted regions; calculating an average number of clusters per stage for each of the groups of stages; calculating an amount of proppant placed in each cluster in each of each of the groups of stages, from a selected total proppant mass and an estimated fraction of the total proppant mass used for each of the groups of stages; simulating fracturing of one of the clusters in each of the groups of stages; and designing the proppant pumping schedule for the clusters in each group, based on the cluster fracture simulation.

### Embodiment 9

the method of Embodiment 1, wherein (d) comprises preparing an ISIP versus stage curve using data from the previous stimulation, and optionally modifying the ISIP versus stage curve, for the establishment of the target ISIP values versus treatment progression in (c) by stage; dividing the target ISIP values into a plurality of groups of stages comprising a low value group, a high value group, and optionally one or more intermediate value groups, preferably intermediate value groups where the low value group and the high value group are separated by a gap between depleted and undepleted regions; estimating an average number of clusters in each of the groups of stages, optionally considering one or more or all of: production data for the well, estimated depletion along the well, production data for nearby offset wells, and estimated depletion along the nearby offset wells; from the estimated average number of clusters per group, estimating a number of clusters in each stage in each of the groups of stages; and calculating the diversion pill volume for the respective stages, based on the estimated number of clusters in each treatment stage in each of the groups of stages.

### Embodiment 10

the method of Embodiment 9, further comprising simulating the refracturing treatment to verify the number of clusters for fracture initiation for the diversion pill in the respective stages, to determine a minimum cluster stress for the respective stages, and to calculate the ISIP for the respective stages as a function of the determined minimum cluster stress.

### Embodiment 11

the method of Embodiment 10, further comprising comparing the calculated stage ISIPs with the target ISIP value to obtain a difference; if the difference is greater than a predetermined amount, modifying the diversion schedule and repeating the refracturing treatment simulation, and repeating the comparison and the diversion schedule modification until the difference is less than the predetermined amount.

### Embodiment 12

the method of Embodiment 10 or Embodiment 11, wherein the refracturing treatment simulation comprises (i) computing flow rate across each unplugged perforation cluster during the stage, and a wellbore pressure required to flow fluid across the unplugged perforations, (ii) determining a fraction of perforations plugged based on the diversion squeeze rate (preferably about 20 bbl/min), the diversion pill volume, and an amount of diverting material required to plug a perforation, preferably captured from user input, (iii) with the fraction of the perforations plugged in (ii), computing the flow rate across each perforation cluster at the squeeze rate, and (iv) repeating (i), (ii), and (iii) for subsequent stages.

### Embodiment 13

the method of any one of Embodiments 10-12, wherein the refracturing treatment simulation ignores fracture initiation pressure, fracture propagation, fracture geometry, and changes in net pressure during the diversion, and wherein the refracturing treatment simulation provides an indication of effect of stress variations along an interval of the wellbore, on a value of diversion pressure, on relative change in the ISIP values, and on number of the clusters taking fluid.

### Embodiment 14

the method of any one of Embodiments 10-12, wherein the refracturing treatment simulation is based on cluster characterization from user inputs selected from one or more or all of: number of perforations, perforation diameter, perforation coefficient, spacing to adjacent clusters, and fracturing gradient of a zone adjacent to the cluster.

### Embodiment 15

the method of any one of Embodiments 9-14, wherein (e) comprises calculating an amount of proppant placed in each cluster in each of the groups of stages, from a selected total proppant mass and an estimated fraction of the total proppant mass used for each of the groups of stages; simulating fracturing of one of the clusters in each of the groups of stages; and designing the proppant pumping schedule for the clusters in each of the groups of stages, based on the fracturing simulation.

### Embodiment 16

the method of Embodiment 1, wherein (d), (e), or a combination thereof, comprise simulating the refracturing treatment for one or more or all of the following: determining a number and location of clusters, modeling propagation of the refracturing treatment fractures in (e) by stage, modeling injection of the diversion pill in (d) by stage, calculating the ISIP in (g) at the end of each stage, and combinations thereof.

### Embodiment 17

The method of Embodiment 16, further comprising iteration process A, iteration process B, or a combination thereof, wherein iteration process A comprises: comparing the calculated ISIP in (g) with the target ISIP value in (d) to obtain a difference; if the difference is greater than a predetermined amount, modifying the diversion schedule in (d) and repeating the refracturing treatment simulation; and repeating the calculated-target ISIP comparison and the diversion schedule modification until the difference is less than the predetermined amount; and wherein iteration process B comprises: comparing the fracture propagation model with target values of the fracture design in (e); if the fracture propagation model-design comparison is unsatisfactory, modifying the proppant pumping schedule in (e) and repeating the refracturing treatment simulation; and repeating the fracture propagation model-design comparison and the proppant pumping schedule modification until the fracture propagation model-design comparison is satisfactory.

### Embodiment 18

The method of any one of Embodiments 1-17, wherein (b) comprises one or more or all of the following: determining starting mechanical property values for the formation along a lateral of the well, wherein the values are selected from Poisson's ratio, Young's modulus in a vertical direction, Young's modulus in a horizontal direction, and combinations thereof, e.g., from sonic logs; determining an initial pre-production reservoir pressure of the formation, e.g., assuming uniform reservoir pressure prior to any production; calculating initial pre-production stress distribution along the lateral from the determined mechanical properties and reservoir pressure, which may be a 1D or 3D model; simulating a geometry of the pre-existing fractures to calculate the geometry and conductivity of the pre-existing fractures, wherein the simulation is based on one or more of the determined mechanical properties, the determined reservoir pressure, the calculated stress distribution, parameters of the previous stimulation, and combinations thereof; conducting reservoir simulation for any production period after the previous stimulation up to the start of the re-stimulation treatment, to match any actual production history data, and to calculate a reservoir pressure field at the start of the re-stimulation treatment, based on the calculated fracture geometry and conductivity; conducting a geomechanics simulation based on the reservoir pressure field to calculate a formation stress field at the start of the re-stimulation treatment; and combinations thereof.

### Embodiment 19

The method of any one of Embodiments 1-17, wherein (b) comprises: determining mechanical property values for the formation along a lateral of the well or from offset wells in the reservoir, wherein the values are selected from vertical Poisson's ratio, horizontal Poisson's ratio, Young's modulus in a vertical direction, Young's modulus in a horizontal direction, and combinations thereof, e.g., from sonic logs; determining statistical distribution of the mechanical property values from measured values; calculating stresses, σₕ, from Equation (1):

$${σ}_{h} = [ \frac{{E}_{h}}{{E}_{v}} ( \frac{{v}_{v}}{1 - {v}_{h}} ) - 1 ] α {p}_{r} \qquad ( 1 )$$

where pr is reservoir pore pressure, Eh and Ev are the horizontal and vertical Young's moduli, νh and νv are the horizontal and vertical Poisson's ratios, and is the poroelastic constant; obtaining first and second distributions of the calculated stresses, where pᵣ in the first distribution is the initial reservoir pore pressure, preferably obtained from the previous stimulation treatment, and where pᵣ in the second distribution is the lowest current pore pressure, preferably estimated from production data; and assigning the first and second distributions to respective first and second groups of clusters corresponding to the undepleted and depleted regions of the formation, respectively.

### Embodiment 20

The method of any one of Embodiments 1-17, wherein (b) comprises: calculating stresses, σₕ, from Equation (1):

$${σ}_{h} = [ \frac{{E}_{h}}{{E}_{v}} ( \frac{{v}_{v}}{1 - {v}_{h}} ) - 1 ] α {p}_{r} \qquad ( 1 )$$

where pr is reservoir pore pressure, Eh and Ev are the horizontal and vertical Young's moduli, νh and νv are the horizontal and vertical Poisson's ratios, and is the poroelastic constant; wherein the Poisson's ratios and Young's moduli are taken as average or representative values obtained from one or more of at least one nearby pilot well, at least one nearby offset well, or a combination thereof; obtaining a distribution of the calculated stresses, using pᵣ as a statistical distribution of reservoir pore pressure along the well, wherein an initial reservoir pressure prior to the previous stimulation treatment is known, and lowest current pore pressure is estimated from production data; and assigning the stress distribution to respective clusters.

### Embodiment 21

The method of any one of Embodiments 1-20, wherein the goal ISIP values in (a) comprise a range of ISIP values from the previous stimulation.

### Embodiment 22

The method of any one of Embodiments 1-21, wherein establishing the minimum target ISIP value in (c) comprises injecting a test volume into the well, shutting in the well, and measuring ISIP, wherein the test volume is less than 20% of a volume of a first one of the stages.

### Embodiment 23

A method for re-stimulation treatment of a well penetrating a formation, comprising: (a) establishing a goal range of instantaneous shut-in pressure (ISIP) values for refracturing treatment of a well having pre-existing fractures from a previous stimulation, wherein the goal range comprises minimum and maximum ISIP values corresponding to undepleted regions of the formation; (b) optionally determining pore pressure and cluster stresses along the well at a start of the re-stimulation treatment; (c) establishing target ISIP values versus treatment progression, wherein the target ISIP values comprise a minimum target ISIP value equal to or greater than a lowest pore pressure in the formation at a start of the re-stimulation treatment corresponding to depleted regions of the formation, and a maximum target ISIP value within the goal range of ISIP values at an end of the re-stimulation treatment corresponding to the undepleted regions; (d) designing a diversion schedule for a number of stages, wherein the schedule comprises the number of stages, a diversion squeeze rate, a diversion pill volume, and the target ISIP value at an end of the respective stage; (e) designing a proppant pumping schedule for a fracture design for the stages, wherein the proppant pumping schedule comprises pump rate, pad volume, proppant loading, and total proppant placement for the respective stage; (f) initiating the refracturing treatment including proppant and diversion pill placement according to the proppant pumping schedule (e) and diversion schedule (d); (g) measuring ISIP at the end of the stages; and (h) if the measured ISIP in (g) differs from the target ISIP value in (c) by a predetermined amount, then adjusting the diversion schedule in (d), the proppant pumping schedule in (e), or a combination thereof, for subsequent treatment stages, optionally in proportion to the difference between the measured and target ISIP value; wherein (d) comprises: preparing an ISIP versus stage curve using data from the previous stimulation, and optionally modifying the ISIP versus stage curve, for the establishment of the target ISIP values versus treatment progression in (c) by stage; dividing the target ISIP values into a plurality of groups of stages comprising a low value group, a high value group, and optionally one or more intermediate value groups, preferably intermediate value groups where the low value group and the high value group are separated by a gap between depleted and undepleted regions; estimating an average number of clusters in each of the groups of stages, optionally considering one or more or all of: production data for the well, estimated depletion along the well, production data for nearby offset wells, and estimated depletion along the nearby offset wells; from the estimated average number of clusters per group, estimating a number of clusters in each stage in each of the groups of stages; and calculating the diversion pill volume for the respective stages, based on the estimated number of clusters in each treatment stage in each of the groups of stages.

### Embodiment 24

The method of any one of Embodiments 1-23, wherein the refracturing treatment in a first one of the stages and one or more subsequent stages creates fractures in the depleted regions of the formation, and wherein the refracturing treatment in an ultimate one of the stages or one or more earlier stages creates fractures in the undepleted regions of the formation.

### Embodiment 25

The method of any one of Embodiments 1-24, wherein the refracturing treatment in (f) and (h) creates short fractures in the depleted regions of the formation relative to long fractures created in the undepleted regions of the formation.

### Embodiment 26

The method of any one of Embodiments 1-25, wherein at least 50% of the proppant placed in the refracturing treatment in (f) and (h) is placed in the undepleted regions of the formation, by cumulative weight of the total proppant placed in each of the stages.

### Embodiment 27

The method of any one of Embodiments 1-26, wherein, if the measured ISIP in (g) exceeds the maximum goal ISIP value, undertaking remedial measures for possible screenout.

### Example

The following nonlimiting example is provided to illustrate the principles of the present disclosure according to some embodiments.

The subject well treated in this example was a generally horizontal lateral. The instantaneous shut-in pressures (ISIPs) encountered during the original completion were recorded as a matter of course, as is typical. The lateral had eight fracturing stages with the ISIP values shown in FIG. 14, ranging from 42.3 to 51.1 MPa (6,134 to 7,414 psi). Because in the original, undrained condition, there would be a consistent pore pressure gradient in a small portion of the reservoir that was contacted by a single well, this variation may reflect differences in elastic properties of the rock. After depletion, the pore pressure in the reservoir was significantly lowered in the portions of the reservoir which were drained, and may still be at the original pressure in areas which were inadequately stimulated during the original completion. In this case, there were eight stages with five perforation clusters in each stage for a total of 40 perforation clusters. Based on well performance and historical production logging data, we assumed that 30 of these perforations were successfully treated as planned during the original stimulation, but 10 remained un-treated and undepleted at or near initial reservoir pressure.

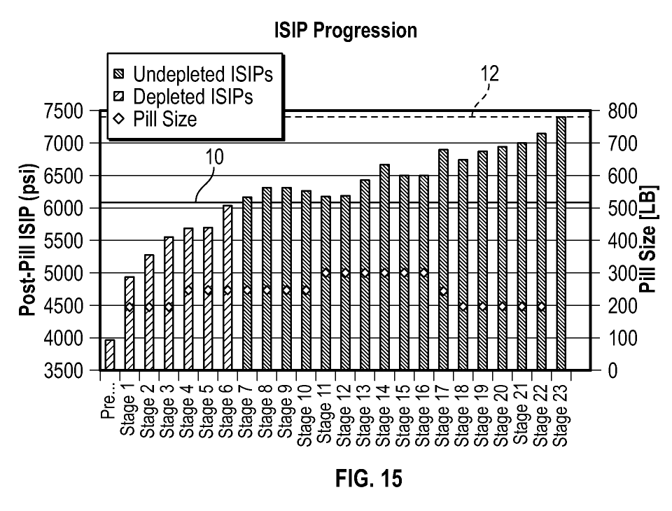

In addition, the design approach for completions such as in the subject well had changed since the initial stimulation, and the new design approach would have placed the clusters much closer together than the earlier version. In this case, two new perforation clusters were to be added for each existing cluster, to be placed between the original clusters for the most of the lateral, and it was assumed that the 72 new clusters would communicate with regions of the formation at or near the initial reservoir pore pressure. To estimate the condition of the lateral prior to the refrac, similar variation in the elastic properties of the rock, and the original pore pressure (70.3 MPa (10,200 psi)), from the original stimulation were assumed. Based on this refrac design, a total of 82 perforation clusters (10 existing and 72 new) with a pore pressure of 70.3 MPa (10,200 psi), and 30 clusters with a pressure of approximately 20.7 MPa (3,000 psi), which was the bottomhole flowing pressure (BHFP) at the time of the re-stimulation. The condition of the wellbore prior to the refrac is represented by the stress histogram seen in FIG. 15, with 30 depleted clusters represented in light fill, and 82 unstimulated clusters in heavy fill.

Next an estimation of the stress condition of the wellbore was undertaken to provide a design basis for the diversion strategy with the appropriate pill volumes. In this example, the goal was to pump smaller reconnecting stages into the depleted rock, and larger re-stimulating stages into the higher pressure areas. With 30 low pressure clusters, experience has shown that approximately five clusters at a time will be stimulated, indicating six stages were needed to target these clusters of the lateral. With approximately five pounds of diversion material required for each perforation, and six perforations per cluster, the estimated mass of diversion material required for the low pressured section was calculated as 30 clusters×6 holes/cluster×2.27 kg (5 lb)/hole=409 kg (900 lb) of diversion material, for approximately 68.2 kg (150 lb) of diversion material in the diversion pill at the end of each of these stages.

For the 82 high-pressure clusters, based again on the assumption of approximately 5 clusters treated for each stage, an additional 17 stages were planned to target this higher pressure rock. With similar assumptions for the mass of diversion material required, these pills should also be about 68.2 kg (150 lb) of diversion material pumped after each stage.

With the staging strategy design in hand, the proppant pumping schedule for each stage was developed. In this example, the initial estimate from experience was that the low pressure clusters would be targeted with 9090 kg (20,000 lb) of proppant per cluster, and the high pressure clusters with 33,660 (74,200 lb) per cluster, or 45,500 kg (100,000 lb) sand for each of the first 6 stages, and 163,000 kg (358,000 lb) for the following 17 stages. Based on these fracturing parameters, two different pumping schedules were developed for stages 1-6 and 7-23 as shown in Table 1 and Table 2, respectively.

TABLE 1
PUMPING SCHEDULE: Low Pressure Stages 1-6

| | Pump | | | | | Slurry | Inj. |
|---|---|---|---|---|---|---|---|
| Stage | Rate, L/s | Fluid | Clean Fluid, | Proppant, | Proppant, | Volume, | Time, |
| Step | (bbl/min) | Type | m³ (1000 gal) | g/L (PPA) | kg (1000 lb) | m³ (bbl) | min |
| 1 | 0 | Gel pad | 47.3 (12.5) | 0 | 0 | 47.3 (298) | 0 |
| 2 | 0 | Gel | 13.2 (3.48) | 0.06 (0.5) | 791 (1.74) | 13.5 (84.7) | 0 |
| 3 | 26.5 (10) | Gel | 1.85 (0.489) | 0.06 (0.5) | 111 (0.244) | 1.89 (11.9) | 1.2 |
| 4 | 146 (55) | Gel | 22.8 (6.03) | 0.06 (0.5) | 1370 (3.02) | 23.4 (147) | 2.7 |
| 5 | 146 (55) | X-linked | 30.3 (8.00) | 0 | 0 | 30.3 (191) | 3.5 |
| | | gel spacer | | | | | |
| 6 | 146 (55) | X-linked | 18.9 (5.00) | 0.12 (1) | 2270 (5.00) | 19.8 (124) | 2.3 |
| | | gel | | | | | |
| 7 | 146 (55) | X-linked | 49.2 (13.0) | 0.36 (3) | 17700 (39.0) | 55.9 (352) | 6.4 |
| | | gel | | | | | |
| 8 | 146 (55) | X-linked | 38.6 (10.2) | 0.6 (5) | 23200 (51.0) | 47.3 (298) | 5.4 |
| | | gel | | | | | |
| 9 | 146 (55) | X-linked | 8.74 (2.31) | 0 | 0 | 8.74 (55) | 1 |
| | | gel spacer | | | | | |
| 10 | 146 (55) | Diversion | 0.038 (0.010) | 0 | 0 | 0 | 44 |
| | | Pill | | | | | |
| 11 | 146 (55) | Gel spacer | 75.1 (20.0) | 0 | 0 | 75.5 (475) | 8.6 |
| 12 | 146 (55) | Slickwater | 60.8 (16.1) | 0 | 0 | 60.8 (382) | 7 |
| | | flush | | | | | |
| Total: | | | 367.3 (97.03) | | 45500 (100) | 384.4 (2418) | 82.1 |

TABLE 2
PUMPING SCHEDULE: High Pressure Stages 7-23

| | Pump | | | | | Slurry | Inj. |
|---|---|---|---|---|---|---|---|
| Stage | Rate, L/s | Fluid | Clean Fluid, | Proppant, | Proppant, | Volume, | Time, |
| Step | (bbl/min) | Type | m³ (1000 gal) | g/L (PPA) | kg (1000 lb) | m³ (bbl) | min |
| 1 | 0 | Gel pad | 51.1 (13.5) | 0 | 0 | 51.1 (321) | 0 |
| 2 | 0 | Gel | 7.68 (2.03) | 0.09 (0.75) | 691 (1.52) | 7.93 (49.9) | 0 |
| 3 | 26.5 (10) | Gel | 1.53 (0.484) | 0.09 (0.75) | 165 (0.363) | 1.89 (11.9) | 1.2 |
| 4 | 146 (55) | Gel | 38.9 (10.8) | 0.09 (0.75) | 3690 (8.120) | 42.4 (266) | 4.8 |
| 5 | 146 (55) | X-linked | 75.7 (20.0) | 0 | 0 | 75.7 (476) | 8.7 |
| | | gel spacer | | | | | |
| 6 | 146 (55) | X-linked | 98.4 (26.0) | 0.12 (1) | 11800 (26.0) | 103 (647) | 11.8 |
| | | gel | | | | | |
| 7 | 146 (55) | X-linked | 102 (27.0) | 0.24 (2) | 24500 (54.0) | 111 (701) | 12.7 |
| | | gel | | | | | |
| 8 | 146 (55) | X-linked | 98.4 (26.0) | 0.36 (3) | 355 (78.0) | 112 (703) | 12.8 |
| | | gel | | | | | |
| 9 | 146 (55) | X-linked | 94.6 (25.0) | 0.48 (4) | 454 (100) | 112 (703) | 12.8 |
| | | gel | | | | | |
| 10 | 146 (55) | X-linked | 75.7 (20.0) | 0.54 (4.5) | 409 (90.0) | 91.1 (573) | 10.4 |
| | | gel | | | | | |
| 11 | 146 (55) | Gel spacer | 8.74 (2.31) | 0 | 0 | 8.74 (55)* | 1 |
| 12 | 146 (55) | BROAD- | 60.6 (16.0) | 0 | 0 | 0 | 44 |
| | | BAND ™ | | | | | |
| 13 | 146 (55) | Gel spacer | 75.5 (20.0) | 0 | 0 | 75.5 (475) | 8.6 |
| 14 | 146 (55) | Slickwater | 59.0 (15.6) | 0 | 0 | 59.0 (371) | 6.8 |
| | | flush | | | | | |
| Total: | | | 790 (208.7) | | 358000 | 851.3 (5355) | 135.6 |

During the refrac real time adjustments were made during execution, based on the methodology described herein. With the diverter and proppant pumping schedule designed, the refrac was initiated and proceeded according to plan for the first three stages, as shown in FIG. 16. At the end of stage 3, and again at the end of stage 10, the ISIP observed was considered to be too low compared to the target ISIPs, and the amount of diversion material used was increased. Then, after stages 16 and 17, the measured ISIP was relatively high, and the amount of diversion material was reduced in subsequent stages. Thus, the ISIP was increased through the use of diversion material during the initial 6 stages, while maintaining the ISIP values corresponding to the initial reservoir pore pressure range indicated in FIG. 15 throughout the remaining 17 stages, without blocking perforations off prematurely, which would have required terminating the treatment prior to stimulating the reservoir to the desired level. The initial 6 stages placed the proppant at pressures lower than the original ISIPs, accounting for 273 metric tons (600,000 lb) of proppant. In the following 17 stages, the proppant was placed within the range of ISIP values corresponding to the initial reservoir pore pressure range, accounting for 2766 metric tons (6,086,000 lb) of proppant. In this example, 91% of the total proppant was placed in the range of the original ISIPs, i.e., the ISIP values corresponding to the initial reservoir pore pressure range.

Although only a few example embodiments have been described in detail above, those skilled in the art will readily appreciate that many modifications are possible in the example embodiments without materially departing from this invention. For example, any embodiments specifically described may be used in any combination or permutation with any other specific embodiments described herein. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for re-stimulation treatment of a well penetrating a subterranean formation, comprising:
(a) establishing a goal range of instantaneous shut-in pressure (ISIP) values for refracturing treatment of a well having pre-existing fractures from a previous stimulation, wherein the goal range comprises minimum and maximum ISIP values corresponding to undepleted regions of the formation;
(b) determining pore pressure and cluster stresses along the well at a start of the re-stimulation treatment;
(c) establishing target ISIP values versus treatment progression, wherein the target ISIP values comprise a minimum target ISIP value equal to or greater than a lowest pore pressure in the formation at a start of the re-stimulation treatment corresponding to depleted regions of the formation, and a maximum target ISIP value within the goal range of ISIP values at an end of the re-stimulation treatment corresponding to the undepleted regions;
(d) designing a diversion schedule for a number of stages, wherein the schedule comprises the number of stages, a diversion squeeze rate, a diversion pill volume, and the target ISIP value at an end of the respective stage;
(e) designing a proppant pumping schedule for a fracture design for the stages, wherein the proppant pumping schedule comprises pump rate, pad volume, proppant loading, and total proppant placement for the respective treatment stage;
(f) initiating the refracturing treatment including proppant and diversion pill placement according to the proppant pumping schedule (e) and diversion schedule (d);
(g) measuring ISIP at the end of the stages; and
(h) if the measured ISIP in (g) differs from the target ISIP value in (c) by a predetermined amount, then adjusting the diversion schedule in (d), the proppant pumping schedule in (e), or a combination thereof, for subsequent stages.

2. The method of claim 1, wherein (d) comprises:
simulating the refracturing treatment to determine for each fracturing stage a number of clusters connected to propagating fractures, a number of clusters plugged by a diversion pill, and the minimum stress of yet unstimulated clusters to calculate the ISIP for the respective stages;
comparing the calculated ISIP with the target ISIP value to obtain a difference;
if the difference is greater than a predetermined amount, modifying the diversion schedule and repeating the refracturing treatment simulation; and
repeating the comparison and the modification until the difference is less than the predetermined amount.

3. The method of claim 2, wherein the refracturing treatment simulation in (1) comprises:
i. computing flow rate across each unplugged perforation cluster during the stage, and a wellbore pressure required to flow fluid across the unplugged perforations;
ii. determining a fraction of perforations plugged based on the diversion squeeze rate (preferably 20 bbl/min), the diversion pill volume, and an amount of diverting material required to plug a perforation (preferably captured from user input);
iii. with the fraction of the perforations plugged in (ii), computing the flow rate across each perforation cluster at the squeeze rate; and
iv. repeating (i), (ii), and (iii) for subsequent stages.

4. The method of claim 3, wherein the refracturing treatment simulation ignores fracture initiation pressure, fracture propagation, fracture geometry, and changes in net pressure during the diversion, and wherein the refracturing treatment simulation provides an indication of effect, of stress variations along an interval of the wellbore, on a value of diversion pressure, on relative change in the ISIP values, and on number of the clusters taking fluid.

5. The method of claim 3, wherein the refracturing treatment simulation is based on cluster characterization from user inputs selected from one or more or all of: number of perforations, perforation diameter, perforation coefficient, spacing to adjacent clusters, and fracturing gradient of a zone adjacent to the cluster.

6. The method of claim 2, wherein the ISIP calculation in (1) comprises adding an estimated net pressure (preferably about 200-1000 psi) to the minimum cluster stress.

7. The method of claim 2, wherein (e) comprises:
dividing the target ISIP values into a plurality of groups of stages comprising a low value group, a high value group, and optionally one or more intermediate value groups;
calculating an average number of clusters per stage for each of the groups of stages;
designing the proppant pumping schedule for one of the clusters in each of the groups of stages, based on a selected total proppant mass;
simulating the proppant pumping schedule to calculate representative fracture geometry and conductivity for each of the groups of stages;
comparing the calculated fracture geometry and conductivity with target geometry and conductivity;
if the comparison is unsatisfactory, modifying the proppant pumping schedule and repeating the refracturing treatment simulation; and
repeating the comparison and the modification until the comparison is satisfactory.

8. The method of claim 2, wherein (e) comprises:
dividing the target ISIP values into a plurality of groups of stages comprising a low value group, a high value group, and optionally one or more intermediate value groups;
calculating an average number of clusters per stage for each of the groups of stages;
calculating an amount of proppant placed in each cluster in each of each of the groups of stages, from a selected total proppant mass and an estimated fraction of the total proppant mass used for each of the groups of stages;
simulating fracturing of one of the clusters in each of the groups of stages; and
designing the proppant pumping schedule for the clusters in each group, based on the cluster fracture simulation.

9. The method of claim 1, wherein (d) comprises:
preparing an ISIP versus stage curve using data from the previous stimulation for the establishment of the target ISIP values versus treatment progression in (c) by stage;
dividing the target ISIP values into a plurality of groups of stages comprising a low value group, a high value group, and optionally one or more intermediate value groups;
estimating an average number of clusters in each of the groups of stages;
from the estimated average number of clusters per group, estimating a number of clusters in each stage in each of the groups of stages; and
calculating the diversion pill volume for the respective treatment stages, based on the estimated number of clusters in each stage in each of the groups of stages.

10. The method of claim 9, further comprising simulating the refracturing treatment to verify the number of clusters for fracture initiation for the diversion pill in the respective treatment stages, to determine a minimum cluster stress for the respective treatment stages, and to calculate the ISIP for the respective treatment stages as a function of the determined minimum cluster stress.

11. The method of claim 10, wherein the refracturing treatment simulation ignores fracture initiation pressure, fracture propagation, fracture geometry, and changes in net pressure during the diversion, and wherein the refracturing treatment simulation provides an indication of effect of stress variations along an interval of the wellbore, on a value of diversion pressure, on relative change in the ISIP values, and on number of the clusters taking fluid.

12. The method of claim 10, wherein the refracturing treatment simulation is based on cluster characterization from user inputs selected from one or more or all of: number of perforations, perforation diameter, perforation coefficient, spacing to adjacent clusters, and fracturing gradient of a zone adjacent to the cluster.

13. The method of claim 9, wherein (e) comprises:
calculating an amount of proppant placed in each cluster in each of the groups of stages from a selected total proppant mass and an estimated fraction of the total proppant mass used for each of the groups of stages;
simulating fracturing of one of the clusters in each of the groups of stages; and
designing the proppant pumping schedule for the clusters in each of the groups of stages, based on the fracturing simulation.

14. The method of claim 1, wherein (d), (e), or a combination thereof, comprise simulating the refracturing treatment for one or more of the following:
determining a number and location of clusters;
modeling propagation of the refracturing treatment fractures in (e) by stage;
modeling injection of the diversion pill in (d) by stage;
calculating the ISIP in (g) at the end of each stage; and
combinations thereof.

15. The method of claim 14, further comprising iteration process A, iteration process B, or a combination thereof, wherein iteration process A comprises:
comparing the calculated ISIP in (g) with the target ISIP value in (d) to obtain a difference;
if the difference is greater than a predetermined amount, modifying the diversion schedule in (d) and repeating the refracturing treatment simulation; and
repeating the calculated-target ISIP comparison and the diversion schedule modification until the difference is less than the predetermined amount; and
wherein iteration process B comprises:
comparing the fracture propagation model with target values of the fracture design in (e);
if the fracture propagation model-design comparison is unsatisfactory, modifying the proppant pumping schedule in (e) and repeating the refracturing treatment simulation; and
repeating the fracture propagation model-design comparison and the proppant pumping schedule modification until the fracture propagation model-design comparison is satisfactory.

16. The method of claim 1, wherein (b) comprises one or more or all of the following:
determining starting mechanical property values for the formation along a lateral of the well or from offset wells in the reservoir, wherein the values are selected from vertical Poisson's ratio, horizontal Poisson's ratio, Young's modulus in a vertical direction, Young's modulus in a horizontal direction, and combinations thereof;
determining an initial pre-production reservoir pressure of the formation;
calculating initial pre-production stress distribution along the lateral from the determined mechanical properties and reservoir pressure;
simulating a geometry of the pre-existing fractures to calculate the geometry and conductivity of the pre-existing fractures, wherein the simulation is based on one or more of the determined mechanical properties, the determined reservoir pressure, the calculated stress distribution, parameters of the previous stimulation, and combinations thereof;
conducting reservoir simulation for any production period after the previous stimulation up to the start of the re-stimulation treatment, to match any actual production history data, and to calculate a reservoir pressure field at the start of the re-stimulation treatment, based on the calculated fracture geometry and conductivity;
conducting a geomechanics simulation based on the reservoir pressure field to calculate a formation stress field at the start of the re-stimulation treatment; and
combinations thereof.

17. The method of claim 1, wherein (b) comprises:
determining mechanical property values for the formation along a lateral of the well or from offset wells in the reservoir, wherein the values are selected from vertical Poisson's ratio, horizontal Poisson's ratio, Young's modulus in a vertical direction, Young's modulus in a horizontal direction, and combinations thereof;
determining statistical distribution of the mechanical property values from measured values;
calculating stresses, σₕ, from Equation (1):
$${σ}_{h} = [ \frac{{E}_{h}}{{E}_{v}} ( \frac{{v}_{v}}{1 - {v}_{h}} ) - 1 ] α {p}_{r} \qquad ( 1 )$$
where pr is reservoir pore pressure, Eh and Ev are the horizontal and vertical Young's moduli, νh and νv are the horizontal and vertical Poisson's ratios, and is the poroelastic constant;
obtaining first and second distributions of the calculated stresses, where pᵣ in the first distribution is the initial reservoir pore pressure, preferably obtained from the previous stimulation treatment, and where pᵣ in the second distribution is the lowest current pore pressure, preferably estimated from production data; and
assigning the first and second distributions to respective first and second groups of clusters corresponding to the undepleted and depleted regions of the formation, respectively.

18. The method of claim 1, wherein (b) comprises:
calculating stresses, σₕ, from Equation (1):
$${σ}_{h} = [ \frac{{E}_{h}}{{E}_{v}} ( \frac{{v}_{v}}{1 - {v}_{h}} ) - 1 ] α {p}_{r} \qquad ( 1 )$$
where pᵣ is reservoir pore pressure, Eₕ and Eᵥ, are the horizontal and vertical Young's moduli, νₕ and νᵥ are the horizontal and vertical Poisson's ratios, and α is the poroelastic constant, wherein the Poisson's ratios and Young's moduli are taken as average or representative values obtained from one or more of at least one nearby pilot well, at least one nearby offset well, or a combination thereof;
obtaining a distribution of the calculated stresses, using pᵣ as a statistical distribution of reservoir pore pressure along the well, wherein an initial reservoir pressure prior to the previous stimulation treatment is known, and lowest current pore pressure is estimated from production data; and
assigning the stress distribution to respective clusters.

19. The method of claim 1, wherein the goal ISIP values in (a) comprise a range of ISIP values from the previous stimulation.

20. The method of claim 1, wherein establishing the minimum target ISIP value in (c) comprises injecting a test volume into the well, shutting in the well, and measuring ISIP, wherein the test volume is less than 20% of a volume of a first one of the stages.

21. The method of claim 1, wherein the refracturing treatment in a first one of the stages and one or more subsequent stages creates fractures in the depleted regions of the formation, and wherein the refracturing treatment in an ultimate one of the stages or one or more earlier stages creates fractures in the undepleted regions of the formation.

22. The method of claim 1, wherein the refracturing treatment in (f) and (h) creates short fractures in the depleted regions of the formation relative to long fractures created in the undepleted regions of the formation.

23. The method of claim 1, wherein at least 50% of the proppant placed in the refracturing treatment in (f) and (h) is placed in the undepleted regions of the formation, by cumulative weight of the total proppant placed in each of the stages.

24. The method of claim 1, wherein, if the measured ISIP in (g) exceeds the maximum goal ISIP value, undertaking remedial measures for screenout.

25. A method for re-stimulation treatment of a well penetrating a formation, comprising:
(a) establishing a goal range of instantaneous shut-in pressure (ISIP) values for refracturing treatment of a well having pre-existing fractures from a previous stimulation, wherein the goal range comprises minimum and maximum ISIP values corresponding to undepleted regions of the formation;
(b) optionally determining pore pressure and cluster stresses along the well at a start of the re-stimulation treatment;
(c) establishing target ISIP values versus treatment progression, wherein the target ISIP values comprise a minimum target ISIP value equal to or greater than a lowest pore pressure in the formation at a start of the re-stimulation treatment corresponding to depleted regions of the formation, and a maximum target ISIP value within the goal range of ISIP values at an end of the re-stimulation treatment corresponding to the undepleted regions;
(d) designing a diversion schedule for a number of stages, wherein the schedule comprises the number of stages, a diversion squeeze rate, a diversion pill volume, and the target ISIP value at an end of the respective stage;
(e) designing a proppant pumping schedule for a fracture design for the stages, wherein the proppant pumping schedule comprises pump rate, pad volume, proppant loading, and total proppant placement for the respective stage;
(f) initiating the refracturing treatment including proppant and diversion pill placement according to the proppant pumping schedule (e) and diversion schedule (d);
(g) measuring ISIP at the end of the stages;
(h) if the measured ISIP in (g) differs from the target ISIP value in (c) by a predetermined amount, then adjusting the diversion schedule in (d), the proppant pumping schedule in (e), or a combination thereof, for subsequent treatment stages;
(i) wherein (d) comprises:
i. preparing an ISIP versus stage curve using data from the previous stimulation, and optionally modifying the ISIP versus stage curve, for the establishment of the target ISIP values versus treatment progression in (c) by stage;
ii. dividing the target ISIP values into a plurality of groups of stages comprising a low value group, a high value group, and optionally one or more intermediate value groups, preferably intermediate value groups where the low value group and the high value group are separated by a gap between depleted and undepleted regions;
iii. estimating an average number of clusters in each of the groups of stages, optionally considering one or more or all of: production data for the well, estimated depletion along the well, production data for nearby offset wells, and estimated depletion along the nearby offset wells; from the estimated average number of clusters per group, estimating a number of clusters in each stage in each of the groups of stages; and
iv. calculating the diversion pill volume for the respective stages, based on the estimated number of clusters in each treatment stage in each of the groups of stages.

26. A method for re-stimulation treatment of a well penetrating a formation, comprising:
(a) designing a diversion schedule for a number of refrac treatment stages, wherein the schedule comprises the number of stages and a target ISIP value at an end of the respective stage;
(b) designing a proppant pumping schedule for a fracture design for the stages;
(c) initiating the refrac treatment including proppant and diversion pill placement according to the proppant pumping schedule (b) and diversion schedule (a);
(d) measuring ISIP at the end of the stages; and
(e) if the measured ISIP in (d) differs from the target ISIP value in (a), adjusting the diversion schedule in (a), the proppant pumping schedule in (b), or a combination thereof, for any subsequent stages.
